(19) United States
(12) Patent Application Publication
(10) Pub. No.: US 2007/0078910 A1
(43) Pub. Date: Apr. 5, 2007

(54) Back-up storage for home network

(76) Inventor: Rajendra Bopardikar, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/241,427

(22) Filed: Sep. 30, 2005

(51) Int. Cl. G06F 17/30

(52) U.S. Cl. 707/204

(57) ABSTRACT

An embodiment of the present invention is a technique to provide back-up storage. A service is searched for back-up storage from a device on a home network. The device advertises presence on the home network. The device is queried for information on the back-up storage. The device is configured to receive a file using the information. The file is transferred to the device.

### BACKGROUND

1. Field of the Invention

Embodiments of the invention relate to the field of microprocessors, and more specifically, to home networking.

2. Description of Related Art

Digital home networking has become increasingly popular. Complete home automation systems may now be installed to control home appliances, lighting, heating, and security and to provide entertainment services such as fully integrated multimedia facilities. As demands for home networking grow, the complexity of computer-based systems increases at an accelerating rate. One particular area of significance in home networking is the storage of data, files, and media streams. A personal video recorder (PVR) may run out of storage while recording a real-time television program. Critical data files on a personal computer (PC) may be accidentally lost or corrupted by attacks from malware on the Internet.

Existing techniques to address the above problem have a number of drawbacks. One simple solution is to periodically back up data files. This method is time-consuming and may not be reliable because the user may forget to back up data. Another method is to allocate a large storage for real-time recording to avoid lack of storage space. This method is expensive and may be wasteful.

### BRIEF DESCRIPTION OF THE DRAWINGS

Embodiments of invention may best be understood by referring to the following description and accompanying drawings that are used to illustrate embodiments of the invention. In the drawings:

FIG. 1A is a diagram illustrating a processing system in which one embodiment of the invention can be practiced.

FIG. 1B is a diagram illustrating a network device in which one embodiment of the invention can be practiced.

FIG. 2 is a diagram illustrating an interface between the control point and the device according to one embodiment of the invention.

FIG. 3 is a flowchart illustrating a process to use back-up storage according to one embodiment of the invention.

FIG. 4 is a flowchart illustrating a process to initialize the control point and device according to one embodiment of the invention.

### DESCRIPTION

An embodiment of the present invention is a technique to provide automatic back-up storage. A service is searched for back-up storage from a device on a home network. The device advertises its presence and service on the home network. The device is queried for information on the back-up storage. The device is configured to receive a file using the information. The file is transferred to the device.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique to provide automatic back up storage for devices connected to a network. In a first embodiment, a unit, such as a PVR, is performing a real-time operation involving storing real-time data (e.g., recoding media streams) in its local storage. When its local storage is about to be used up, the PVR automatically transfers a file or files from its local storage to a back-up storage device connected to the network. In a second embodiment, a personal computer (PC) on a home network performs back-up of its critical data or files by transferring these critical data or files to a back-up storage automatically at a scheduled time.

Elements of embodiments of the invention may be implemented by hardware, firmware, software or any combination thereof. The term hardware generally refers to an element having a physical structure such as electronic, electromagnetic, optical, electro-optical, mechanical, electro-mechanical parts, components, or devices, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc. A block diagram may contain blocks or modules that describe an element, an item, a component, a device, a unit, a subunit, a structure, a method, a process, a function, an operation, a functionality, or a task, etc. A functionality or an operation may be performed automatically or manually.

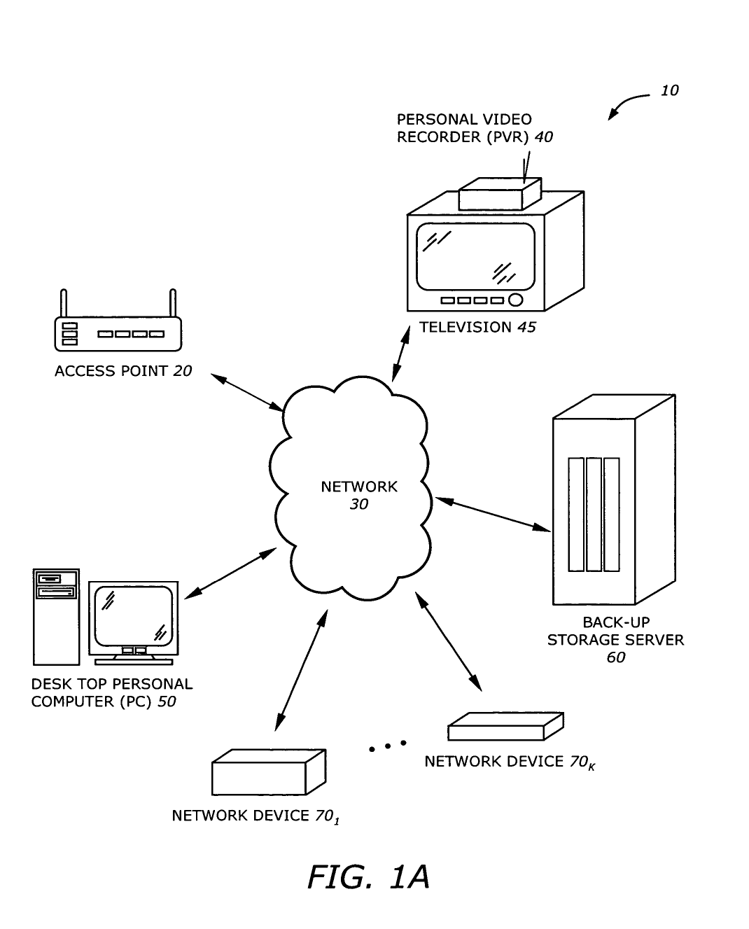

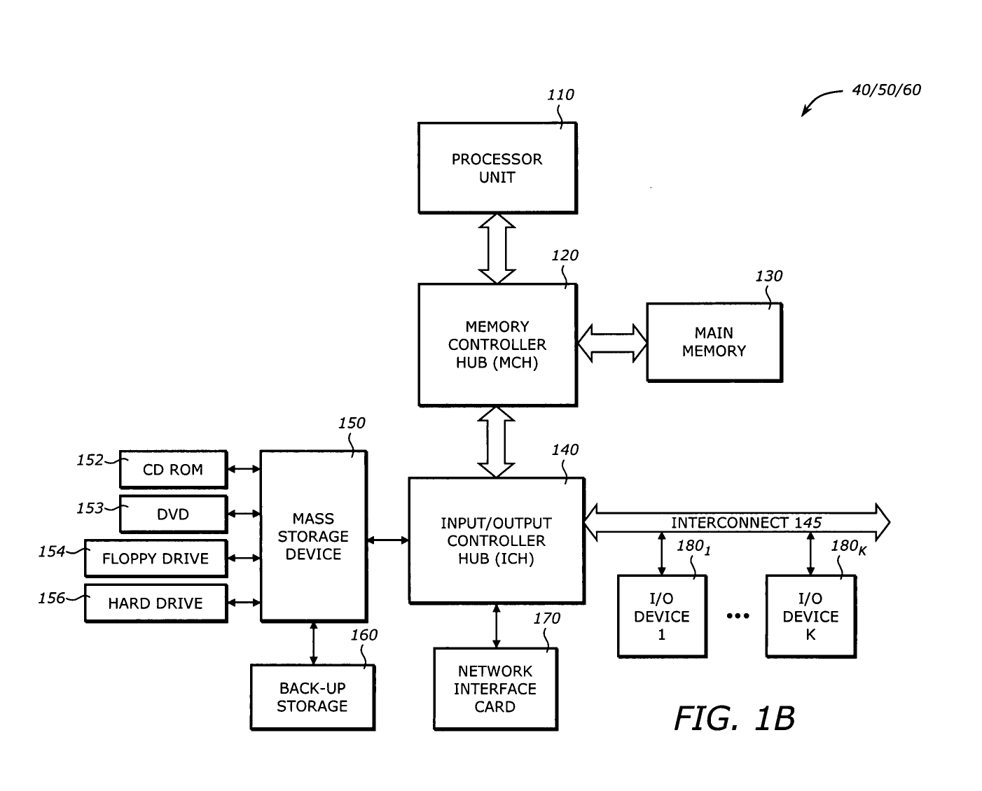

FIG. 1A is a diagram illustrating a processing system 10 in which one embodiment of the invention can be practiced. The processing system 10 includes an access point 20, a network 30, a PVR 40, a television set 45, a personal computer (PC) 50, a back-up storage server 60, K network devices 70₁ to 70_{K}. The processing system 10 illustrates a typical home network system and may contain more or less than the above components or devices. It may depict a home or office network environment.

The access point 20 is a wireless fidelity (Wi-Fi) base station that provides access to all devices that are connected to the network 30. It serves as a central point for the wireless local area network (WLAN) 30. It may join an existing broadband router/switch. It typically uses the Institute of Electrical and Electronics Engineer (IEEE) 801.11 standards such as the 801.11b that supports a maximum bandwidth of 11 Megabits per second (Mbps). It may provide 128-bit Wired Equivalent Privacy (WEP) encryption for security, Media Access Control (MAC) address filtering, and Dynamic Host Configuration Protocol (DHCP) client support. It typically includes a wireless router and switch to support Internet connection sharing. It may also provide firewall protection. The access point 20 is usually located at a strategic location in the home environment that avoids obstruction or interferences from other devices and provides the best distances to all the devices that are connected to the network 30.

The network 30 represents a network that has standardized network protocols. It is typically a local area network (LAN). It may be wired using Ethernet or wireless using Wi-Fi technology. In one embodiment, it is a home network that uses Universal Plug-and-Play (UPnP) standard or any protocol that operates in a similar manner as provided by the UPnP standard. The network 30 may support a number of standards or protocols such as Hypertext Transfer Protocol (HTTP), HyperText Markup Language (HTML), eXtensible Markup Language (XML), Simple Object Access Protocol (SOAP), the Document Object Model, Transmission Control Protocol/Internet Protocol (TCP/IP), and Internet Protocol (IP) multicast. The UPnP protocol allows network devices to communicate with one another in standardized formats. In a UPnP network, there are three basic components: devices, services, and control points. A “device” is any network device that provides service. It may be a PC, a printer, a scanner, a media player, etc. A “service” includes operations that may be performed by the device, such as playing media streams, transferring data to back-up storage, etc. A “control point” is a network device that controls or manipulates the “device”. It may be a PVR, a PC, a scanner, a media player, etc. A network device that is UPnP-enabled has drivers or application program interfaces that are compatible with the UPnP protocols.

The PVR, or digital video recorder (DVR), 40 records media streams such as television programs. It may include a central processing unit, memories, an operating system, device drivers, a user interface, a display panel, and a network interface. In particular, it is connected to the network 30 via the access point 20 or through a wired connectivity. Typically, it may be programmed by the user to record selected programs or shows. It may automatically keep up with schedule changes. It saves the recorded program on a hard disk or local storage inside the unit. The PVR 40 is connected to the television set, a cable TV wire, antenna or satellite box, or a video cassette recorder. After a real-time program is recorded on the local storage, the user may view the recorded programs at a later time. Typically, the PVR 40 is programmed or set up to record many programs, such as daily episodes of a particular show. Once set up, it automatically records the programs without user's intervention. The internal local storage may have limited capacity. Therefore, when the local storage runs out of space, a program may not be recorded or previously recorded programs may be erased to make room for the newly recorded program. In one embodiment, the PVR 40 is UPnP-enabled and has applications program interface to communicate with other devices connected to the network 30 using the UPnP protocols. In the first embodiment, the PVR 40 may be configured as a control point to transfer files containing the recorded programs to an external back-up storage. The PVR 40 represents devices that perform storing media streams on a real-time basis. The first embodiment of the invention may be used for devices other than the PVR 40.

The television (TV) set 45 is any television or media receiver. It may be an analog or digital TV. As an analog TV, it may support National Television System Committed (NTSC) standard having Conventional Definition Television (CDTV) resolutions such as 525 scan lines with 4:3 aspect ratio. As a digital TV, it may support Advanced Television System Committee (ATSC) standards having Standard Definition TV (SDTV) resolutions (e.g., 480×704, 480×640) with 4:3/16:9 aspect ratios, or High Definition TV (HDTV) resolutions (e.g., 1080×1920, 720×1280) with 16:9 aspect ratio. The TV set 45 may include an integrated receiver to receive real-time broadcast programs from cable or satellite. It is connected to the PVR 40 to allow the PVR 40 to record media streams.

The personal computer (PC) 50 is a computer system having a processing unit; memory, mass storage (e.g., hard disk), a display monitor, input devices (e.g., keyboard, mouse, tablet digitizer, camera, scanner), output devices (e.g., printer, audio). The PC 50 has may have a direct interface to the network 30 using a wired connectivity or via the access point 20. It may have a mass storage large enough to serve as an additional or back-up storage for another device. In one embodiment, it is UPnP-enabled to be able to communicate with devices connected to the network 30 using the UPnP protocol. In the first embodiment, it may be configured as a UPnP device to provide back-up service for the PVR 40 when the PVR 40 is about to use up its local storage. In the second embodiment, it may be configured as a control point to transfer critical files or data to the back-up storage server 60 at appropriate times via the network 30.

The back-up storage device or server 60 is a device having a large mass storage to provide back-up service to other devices connected to the network 30. It may be another PC that has a back-up functionality. It may have a central processing unit, memory, interface devices, etc. It may include a network attached storage (NAS) device, high capacity (e.g., 20 GB) solid state cache memory, Redundant Array of Inexpensive Disks (RAID's), tape library storage, Integrated Drive Electronics (IDE), Advanced Technology (AT) Attachment (ATA), enhanced IDE, ultra-ATA, serial ATA (SATA), Small Computer Serial Interface (SCSI), serial attached SCSI (SAS), etc. In one embodiment, it is UPnP-enabled to be able to communicate with other devices connected to the network 30 using the UPnP protocol. In the first and second embodiments, it may be configured as a UPnP device to store files transferred from the PVR or PC to its back-up storage. The transferred files or data may be any type of data such as documents, data files, program files, media files, zipped files, etc. organized in any format.

The network devices 70₁ to 70_{K} may be any devices that are connected to the network 30 to communicate with other devices. They may include a media adapter or server, a media player, a printer, a camera system, a scanner, a personal digital assistant (PDA), a notebook computer, a laptop or desktop PC, etc. The media adapter or server provides media content and sends that content to other devices or equipment via the network 30. It may be another PVR, another TV set, a CD or DVD juke box, etc. The media player receives external media content from the other devices via the network 30 and plays or renders the content on its local hardware. It may be a DVD player, a stereo equipment, a game console, etc. In one embodiment, they are UPnP-enabled to be able to communicate with one another or with other devices connected to the network 30 using the UPnP protocols.

FIG. 1B is a diagram illustrating the network device 40/50/60 in which one embodiment of the invention can be practiced. The network device 40/50/60 includes a processor unit 110, a memory controller hub (MCH) 120, a main memory 130, an input/output controller hub (ICH) 140, an interconnect 145, a mass storage device 150, a network interface card 170, and input/output (I/O) devices 180₁ to 180_{K}.

The processor unit 110 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MCH 120 provides control and configuration of memory and input/output devices such as the main memory 130 and the ICH 140. The MCH 120 may be integrated into a chipset that integrates multiple functionalities such as graphics, media, host-to-peripheral bus interface, memory control, power management, etc. The MCH 120 or the memory controller functionality in the MCH 120 may be integrated in the processor unit 110. In some embodiments, the memory controller, either internal or external to the processor unit 110, may work for all cores or processors in the processor unit 110. In other embodiments, it may include different portions that may work separately for different cores or processors in the processor unit 110.

The main memory 130 stores system code and data. The main memory 30 is typically implemented with dynamic random access memory (DRAM), static random access memory (SRAM), or any other types of memories including those that do not need to be refreshed. The main memory 130 may include a back-up storage module 135 that contains a program or instructions to perform back-up storage functions either as a sender or a receiver.

The ICH 140 has a number of functionalities that are designed to support I/O functions. The ICH 140 may also be integrated into a chipset together or separate from the MCH 120 to perform I/O functions. The ICH 140 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, etc.

The interconnect 145 provides interface to peripheral devices. The interconnect 145 may be point-to-point or connected to multiple devices. For clarity, not all the interconnects are shown. It is contemplated that the interconnect 145 may include any interconnect or bus such as Peripheral Component Interconnect (PCI), PCI Express, Universal Serial Bus (USB), and Direct Media Interface (DMI), etc.

The mass storage device 150 stores archive information such as code, programs, files, data, and applications. The mass storage device 150 may include compact disk (CD) read-only memory (ROM) 152, digital video/versatile disc (DVD) 153, a floppy drive 154, and a hard drive 156, and any other magnetic or optic storage devices. It may also include a back-up storage 160 that receives data or files transferred from another device via the network 30 for back-up purposes. The mass storage device 150 provides a mechanism to read machine-accessible media that contain instructions or programs to perform the functions below.

The network interface card 170 provides interface to the network 30. It may have circuits to support wired or wireless connectivity. It may use an external transceiver or an internal integrated transceiver. It may contain the protocol control firmware and Ethernet controller to support the MAC data link protocol used by the Ethernet. For wireless connectivity, it may have circuitry to provide Wi-Fi functionality including 801.11b compatibility.

The I/O devices 180₁ to 180_{K} may include any I/O devices to perform I/O functions. Examples of I/O devices 180₁ to 180_{K} include controller for input devices (e.g., keyboard, mouse, trackball, pointing device), media card (e.g., audio, video, graphic), and any other peripheral controllers.

Embodiments of the invention provide an efficient back-up technique to save critical data or files to a back-up storage device using the UPnP home network protocol. In the first embodiment, the PVR 40 (FIG. 1A) is programmed to record real-time media streams from the television 45 to its local storage. When the local storage is about to run out of space such as when its remaining space exceeds some predefined minimum value, the PVR 40 starts transferring a certain amount of data or files on its local storage to the PC 50 or the back-up storage device 60. The predefined minimum value is calculated such that the time to transfer the files is fast enough so that after the transfer is completed, the local storage may have extra storage space to store the media stream while recording is in progress. After the recording is complete, the user may be informed of the back-up activity and may decide to delete certain files in the local storage to have room for the backed-up files. The PVR 40 may then retrieve the files that have been saved in the back-up storage and save them in its local storage so that the saved programs may be replayed. In the second embodiment, the PC 50 may contain a certain files or data designated to be critical and need to be backed up on a regular basis. The scheduled back-up time may be a time that there is little or no network activity such as at midnight or in the early morning. When it is time to back up, the PC 50 starts transferring these critical data or files to the back-up storage 60. In both embodiments, when the back-up storage itself is about to run out of space, another back-up storage may be used. The interactions or communications between the PVR 40, or the PC 50, and the back-up storage 60 are efficiently carried out through an interface at each of the devices according to the UPnP protocols.

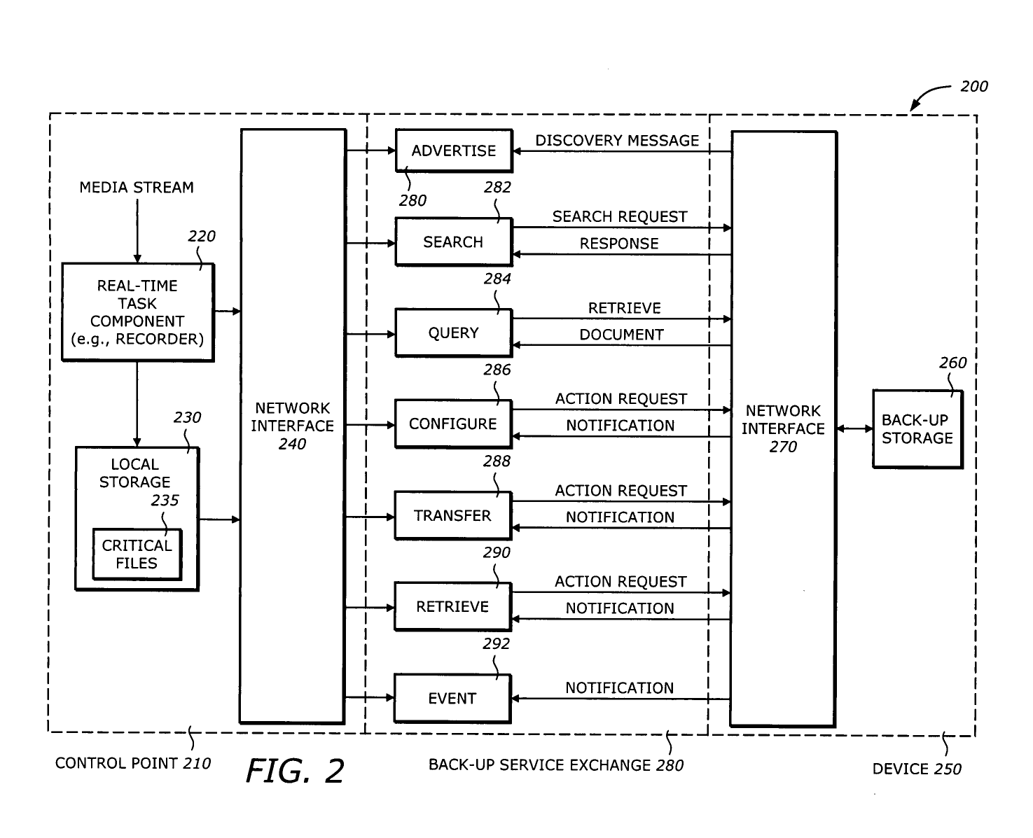

FIG. 2 is a diagram illustrating an interface 200 between the control point and the device according to one embodiment of the invention. The interface 200 includes a control point 210, a device 250, and a back-up service exchange 280.

The control point 210 is a network device that has the ability to control another network device that advertises its service on the network 30. In the first embodiment, it is a device that performs a real-time recording or storage task such as the PVR 40 shown in FIG. 1A. In the second embodiment, it is the PC 50 (FIG. 1A) that has critical data or files that need back-up at some scheduled time intervals. It includes a real-time task component 220, a local storage 230 and a network interface 240. In the first embodiment, the real-time task component 220 performs real-time operations such as recording a media stream. In the second embodiment, the real-time task component 220 may be optional, i.e., the PC 50 does not have to perform a real-time task at the time the back-up takes place. The local storage 230 provides mass storage to store the local data such as the recorded media stream. It may be a hard disk, an electronic disk (e.g., high capacity flash memory), or any mass storage media. The local storage 230 may contain critical data or files 235. The critical file 235 may be the recorded real-time data (e.g., television programs) or any other important files that need to be backed up whether or not the local storage is about to run out of space. Typically, the local storage 230 has a limited capacity and may run out of space. For real-time. storage, to avoid loss of data, it is therefore necessary to be able to transfer the recorded real-time data or files from the local storage 230 to an external back-up storage when the local storage 230 is about to run out of space whether or not the recording is in progress. The network interface 240 is a functionality to provide communication to the device 250 for the back-up service. It may include hardware and software components that are used for UPnP communication such as network interface card, applications program interface, drivers, etc.

The device 250 is a network device that advertises its presence and service to other devices or control points connected to the network 30. In the first embodiment, it may be the PC 50 or the back-up storage server 60 shown in FIG. 1A. In the second embodiment, it may be the back-up storage server 60. It includes a back-up storage 260 and a network interface 270. The back-up storage 260 is a mass storage that is sufficiently large to back up critical files from, or to provide additional storage for, the control point 210. It may be configured by the control point 210 to store the backed up data or files. The network interface 270 is a functionality to provide communication to the control point 210 for the back-up service. It may include hardware and software components that are used for UPnP communication such as network interface card, applications program interface, drivers, etc.

The back-up service exchange 280 includes a number of exchanges between the control point 210 and the device 250 to establish contact and to carry out the back-up operation. It includes an advertise function 280, a search function 282, a query function 284, a configure function 286, a transfer function 288, a retrieve function 290, and an event function 292.

The advertise function 280 is provided by the device 250 to advertise its presence and service to the network 30. When the device 250 is added to the network 30, it multicasts discovery messages to advertise its service to all the control points on the network 30 in a discovery process. In this case, the service is to provide additional or back-up storage. In one embodiment, the advertise function 280 uses the General Event Notification Architecture (GENA) and Simple Service Discovery Protocol (SSDP) message formats according to the UPnP protocol. Each discovery message may contain a potential search target indicating the device type (e.g., back-up storage), an advertisement identifier, a location pointer, and a duration for which the advertisement is valid. The location pointer may be a Uniform Resource Locator (URL) to point to a location that contains more information about the device.

The search function 282 is provided by the control point 210 to search for a device that provides additional or back-up storage. When the control point 210 is added to the network 30, it multicasts a search message to devices on the network. In one embodiment, the search function 282 uses the HTTP and SSDP message formats. In response to the search request, the device 250 unicasts a response to the control point 210. The response contains a location pointer (e.g., an URL) to the description of the device 260.

The query function 284 is provided by the control point 210 to retrieve the description of the device 250 and its service. This may be performed by issuing an HTTP GET request on the URL in the discovery message. The device 250 returns a document that contains the information about the back-up storage service. The information may include a list of commands, or actions, that allow the control point 210 to control the device 250 and a file transfer protocol that the device 250 supports for transferring files to the back-up storage. The information may also contain the total amount of storage space of the back-up storage 260 and the remaining storage amount. By knowing the remaining storage amount, the control point 210 may be able to determine if the back-up storage itself may be about to run out of space so that it may search for another back-up storage device. In one embodiment, the document is written in XML format or any other non-standard format that may be parsed or understood by the control point 210.

The configure function 286 is provided by the control point 210 to configure the back-up storage 260 in the device 250. It is an action request to invoke an action on the service provided by the device 250. The device 250 may return a result or status of the action, such as whether or not the action is successful or has an error. In one embodiment, the configure function 286 uses SOAP, HTTP, and TCP/IP formats. The configure function 286 may include an action to set a current directory on the back-up storage 260 that stores the backed-up data or files, create directory or a subdirectory, authenticate, delete a file, delete a folder, subdirectory or directory, set a mode such as overwrite-old-version, read-only, do-not-delete, etc.

The transfer function 288 is provided by the control point 210 to transfer a file from the local storage 230 to the back-up storage 260 at a specified location or directory that has been created by the configure function 286. The transfer function 288 is an action request. The device 250 may return a result or status of the transfer.

The retrieve function 290 is provided by the control point 210 to retrieve a file from the back-up storage 260 at a specified location. It is an action request. The device 250 may return the requested file, a result or status of the retrieval.

The event function 292 is provided by the device 250 to send a notification on a condition of the device 250 such as a state change. In one embodiment, the event function 292 uses the HTTP and XML formats.

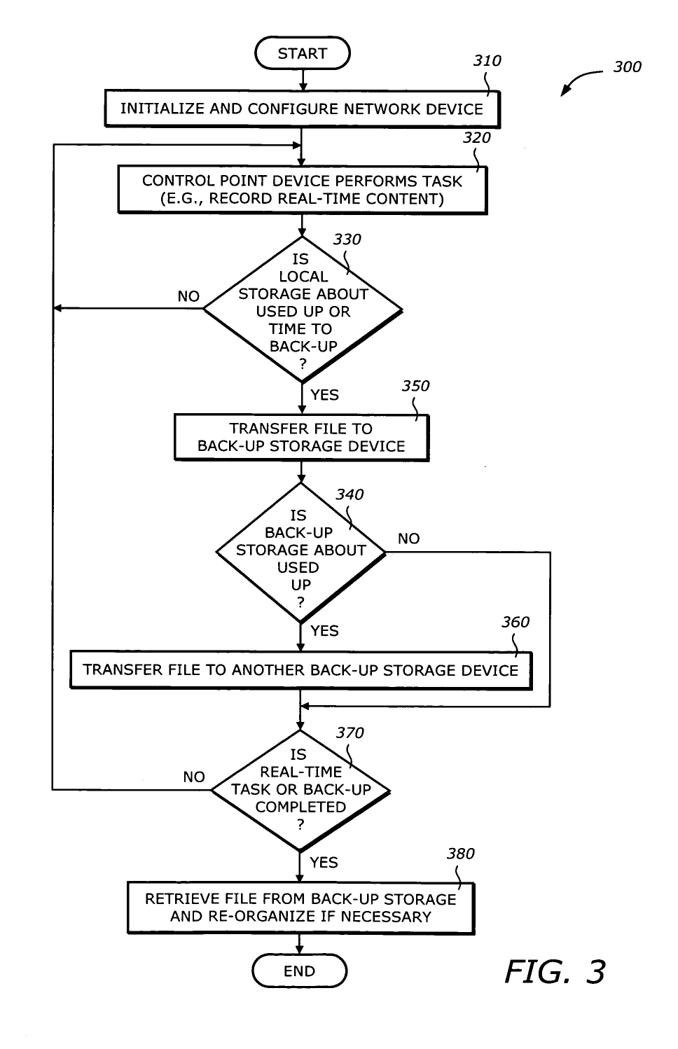

FIG. 3 is a flowchart illustrating a process 300 to use back-up storage according to one embodiment of the invention.

Upon START, the process 300 initializes and configures the network devices including the control points and the back-up storage device (Block 310). Next, the control point performs the real-time task such as recording real-time media streams (Block 320). This operation may be optional for the second embodiment. Then, the process 300 determines if the local storage is about to be used up or runs out of space or if it is time to back up the critical files in the local storage (Block 330). If not, the process 300 returns to Block 320. Otherwise, the process 300.determines if the back up storage is about to be used up or to run out of space (Block 340). This may be performed by keeping track of the total amount of space that the files have been transferred so far and comparing it with the remaining storage amount on the back-up storage. If the back-up storage still has enough remaining space, the process 300 transfers a file from the local storage to the back-up storage using a file transfer protocol supported by the back-up storage device (Block 340) and goes to Block 370. Otherwise, the process 300 transfers a file to another back-up storage device that has been configured (Block 360).

Then, the process 300 determines if the real-time task or the back-up of the critical files has been completed (Block 370). If not, the process 300 returns to Block 320 to continue the real-time task. Otherwise, the process 300 retrieves the file from the back-up storage and re-organizes the files if necessary (Block 380) and is then terminated.

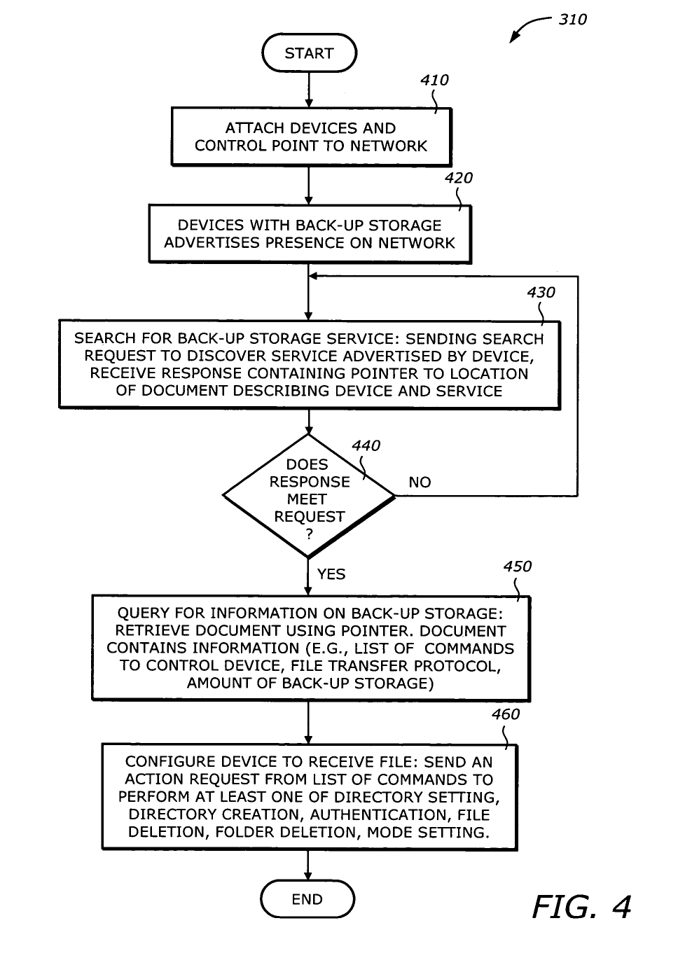

FIG. 4 is a flowchart illustrating the process 310 to initialize and configure the control point and device according to one embodiment of the invention.

Upon START, the process 310 attaches devices and a control point to the network (Block 410). The control points may be a personal video recorder, a PC, or any device that may need additional or back-up storage. Then, the device(s) having back-up storage advertises the presence on the network (Block 420). This may be performed by multicasting an advertisement to the control points.

Then the process 310 searches for back-up storage devices (Block 430). This may be accomplished by sending a search request to discover service advertised by the device(s) and receiving a response containing a pointer to a location of a document describing the device and service. The pointer may be a Uniform Resource Locator (URL). Next, the process 310 determines if the response meet the requirements for a back-up storage (Block 440). If not, the process returns to Block 430 to continue searching for one or more suitable back-up storage devices. Otherwise, the process 310 queries for information on the back-up storage (Block 450). This may be performed by retrieving the document using the pointer provided in the response from the device. The document contains information such as list of commands to control the device, the file transfer protocol supported by the device, the amount of storage on the back-up storage, including the total amount or capacity and the remaining storage amount, etc.

Next, the process 310 configures the device to receive files (Block 460). This may be performed by sending an action request from the list of commands to perform at least one of a directory setting, a directory creation, an authentication procedure, a file deletion, a folder/directory/sub-directory, and a mode setting. The process 310 is then terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
searching for a service for back-up storage from a device on a home network, the device advertising presence on the home network;
querying the device for information on the back-up storage;
configuring the device to receive a file using the information; and
transferring the file to the device.

2. The method of claim 1 wherein searching comprises:
sending a search request to discover the service advertised by the device; and
receiving a response from the device, the response containing a pointer to a location of a document describing the device and the service.

3. The method of claim 2 wherein querying comprises:
retrieving the document using the pointer, the document containing the information on the back-up storage, the information including at least a list of commands to control the device, a storage amount, and a file transfer protocol supported by the device.

4. The method of claim 3 wherein configuring comprises:
sending an action request from the list of commands to perform at least one of directory setting, directory creation, authentication, file deletion, folder deletion, and mode setting.

5. The method of claim 3 wherein transferring comprises:
transferring the file using the file transfer protocol.

6. The method of claim 3 further comprising:
retrieving the file from the device using the file transfer protocol.

7. The method of claim 1 wherein searching comprises:
searching for the service on the home network using Universal Plug and Play (UPnP) protocol.

8. An article of manufacture comprising:
a machine-accessible medium including data that, when accessed by a machine, cause the machine to perform operations comprising:
searching for a service for back-up storage from a device on a home network, the device advertising presence on the home network;
querying the device for information on the back-up storage;
configuring the device to receive a file using the information; and
transferring the file to the device.

9. The article of manufacture of claim 8 wherein the data causing the machine to perform searching comprises data that, when accessed by a machine, cause the machine to perform operations comprising:
sending a search request to discover the service advertised by the device; and
receiving a response from the device, the response containing a pointer to a location of a document describing the device and the service.

10. The article of manufacture of claim 9 wherein the data causing the machine to perform querying comprises data that, when accessed by a machine, cause the machine to perform operations comprising s:
retrieving the document using the pointer, the document containing the information on the back-up storage, the information including at least a list of commands to control the device, a storage amount, and a file transfer protocol supported by the device.

11. The article of manufacture of claim 10 wherein the data causing the machine to perform configuring comprises data that, when accessed by a machine, cause the machine to perform operations comprising:
sending an action request from the list of commands to perform at least one of directory setting, directory creation, authentication, file deletion, folder deletion, and mode setting.

12. The article of manufacture of claim 10 wherein the data causing the machine to perform transferring comprises data that, when accessed by a machine, cause the machine to perform operations comprising:
transferring the file using the file transfer protocol.

13. The article of manufacture of claim 10 further comprising data that, when accessed by a machine, cause the machine to perform operations comprising:
retrieving the file from the device using the file transfer protocol.

14. The article of manufacture of claim 8 wherein the data causing the machine to perform searching comprises data that, when accessed by a machine, cause the machine to perform operations comprising:
searching for the service on the home network using Universal Plug and Play (UPnP) protocol.

15. A system comprising:
a device advertising presence on a home network, the device having a back-up storage; and
a personal video recorder (PVR) to record a real-time media content, the PVR being connected to the home network, the PVR having a processor and a memory containing instructions that, when executed by the processor, cause the processor to:
search for a service for the back-up storage from the device,
query the device for information on the back-up storage,
configure the device to receive a file containing the recorded real-time media content using the information, and
transfer the file to the device.

16. The system of claim 15 wherein the instructions causing the processor to search comprises instructions that, when executed by the processor, cause the processor to:
send a search request to discover the service advertised by the device; and
receive a response from the device, the response containing a pointer to a location of a document describing the device and the service.

17. The system of claim 16 wherein the instructions causing the processor to query comprises instructions that, when executed by the processor, cause the processor to:
retrieve the document using the pointer, the document containing the information on the back-up storage, the information including at least a list of commands to control the device, a storage amount, and a file transfer protocol supported by the device.

18. The system of claim 17 wherein the instructions causing the processor to configure comprises instructions that, when executed by the processor, cause the processor to:
send an action request from the list of commands to perform at least one of directory setting, directory creation, authentication, file deletion, folder deletion, and mode setting.

19. The system of claim 17 wherein the instructions causing the processor to transfer comprises instructions that, when executed by the processor, cause the processor to:
transfer the file using the file transfer protocol.

20. The system of claim 15 wherein the instructions causing the processor to search comprises instructions that, when executed by the processor, cause the processor to:
search for the service on the home network using Universal Plug and Play (UPnP) protocol.
